(19) United States
(12) Patent Application Publication
(10) Pub. No.: US 2026/0358938 A1
(43) Pub. Date: Nov. 12, 2026

(54) EXTRACTING FEATURES FROM A MEDIA INSTANCE

(71) Applicant: Expedia, Inc., Seattle, WA (US)

(72) Inventors: Abi Ashok, Seattle, WA (US); Coline Boudeville, Seattle, WA (US); Danny Godbout, Seattle, WA (US); Jonathan Scott Noblit, Seattle, WA (US); Krishna Jay Rana, Seattle, WA (US); Rohit Kamath, Seattle, WA (US)

(73) Assignee: Expedia, Inc., Seattle, WA (US)

(21) Appl. No.: 19/669,704

(22) Filed: May 6, 2026

Related U.S. Application Data
(60) Provisional application No. 63/801,480, filed on May 7, 2025.

(51) Int. Cl. G06F 3/0484; G06F 40/284

(52) U.S. Cl. CPC G06F 3/0484; G06F 40/284

(57) ABSTRACT

Systems and methods are described for extracting features from a media instance. Example systems can be configured to obtain, from a client device, a request to generate an itinerary including a media instance. The systems can be configured to obtain input data including the media instance that is a location-linked video and provide input data to a predictive model. The predictive model can generate an output including an intermediate set of data objects. The system can be configured to compare the intermediate set of data objects with entries in an inventory database to create a final set of data objects matching items in the database. In some examples, the system can generate user interface data to cause a client device can display a user interface based on the final set of data objects.

### CROSS-REFERENCE TO RELATED APPLICATION

This application claims the benefit of and priority to U.S. Provisional Patent Application No. 63/801,480, filed May. 7, 2025, and entitled “EXTRACTING FEATURES FROM A MEDIA INSTANCE,” the contents of which is incorporated by reference herein in its entirety for all purposes.

### BACKGROUND

In a conventional client-server reservation platform, a user can submit a reservation request that is processed by a back-end server to provide the user with options to select from. Each reservation request may launch a series of discrete server procedures (sets of executable operations) and associated data transfers, reflecting an underlying architecture whose control granularity is relatively coarse and therefore imprecise. Because users are offered broad sets of options, they then may adjust and re-execute the reservation request multiple times before settling on a final request. This cumbersome process may be iteratively repeated, compounding latency and user frustration.

### SUMMARY

For the aforementioned reasons, there is a need for systems and methods that not only execute reservation requests with greater precision and efficiency but also accept more dynamic forms of user input (including images, voice recordings, or other rich media) and automatically translate such inputs into accurate, real-time responses while reducing server load and latency.

In an embodiment, a system is disclosed. The system can include at least one processing circuit. The at least one processing circuit can include at least one memory and one or more processors configured to: obtain input data associated with a media instance. The media instance can be associated with a video corresponding to a geolocation and/or a travel theme. The one or more processors can be configured to provide the media instance as input to a predictive model to cause the predictive model to generate an intermediate set of data objects. The one or more processors can be configured to determine a final set of data objects based on the intermediate set of data objects and an inventory database. The final set of data objects can include a plurality of data objects maintained in the inventory database and mapped to the intermediate set of data objects. The one or more processors can be configured to generate user interface data configured to cause a client device having a display to generate a user interface on the display in accordance with the final set of data objects.

In at least some aspects, the input data can be associated with a geolocation, and the one or more processors configured to determine the final set of data objects can be configured to determine a subset of data objects maintained in the inventory database that correspond to the geolocation. The one or more processors configured to determine the final set of data objects based on the subset of data objects maintained in the inventory database.

In some aspects, the input data can be associated with a travel theme, and the one or more processors configured to determine the final set of data objects can be configured to determine a subset of data objects maintained in the inventory database that correspond to the travel theme. The one or more processors configured to determine the final set of data objects based on the subset of data objects maintained in the inventory database.

In some aspects, the one or more processors configured to obtain the input data can be configured to: establish a communication connection with the client device in accordance with an application programming interface (API). The one or more processors can be configured to obtain the media instance from the client device or from a service hosting the media instance based on user input received at the client device indicating selection of at least a portion of the media instance.

In some aspects, the predictive model can include a vision language model. The one or more processors configured to provide the media instance as the input to the predictive model can be configured to generate a tokenized input that is compatible with the vision language model based on the media instance. The one or more processors can be configured to provide the tokenized input as the input to the predictive model to cause the predictive model to generate the intermediate set of data objects.

In some aspects, the intermediate set of data objects can include a first intermediate set of data objects and the predictive model can include a first predictive model. The one or more processors can be configured to provide the first intermediate set of data objects to a second predictive model to cause the second predictive model to generate a second intermediate set of data objects. Each data object of the second intermediate set of data objects can include a text string.

In at least some aspects, the one or more processors can be configured to determine a mapping between the second intermediate set of data objects and elements stored in the inventory database. The one or more processors can be configured to determine the final set of data objects based on the mapping.

In some aspects, the one or more processors configured to generate the user interface data can be configured to generate an ordered set of images and text objects in accordance with a time series, The one or more processors can be configured to generate the user interface data in accordance with the ordered set of images and text objects to cause the client device to render a user interface on the display.

In some aspects, the one or more processors can be further configured to obtain one or more device parameters indicating one or more aspects of the display. The one or more processors can be configured to generate the user interface data in accordance with the one or more device parameters to cause the ordered set of images and text objects to be displayed according to at least one dimension of the display.

In some aspects, the one or more processors can be further configured to obtain user input data indicating a user interaction with the display. The one or more processors can be configured to provide the user input data as input to a dialogue system to cause the dialogue system to generate a dialogue string of text, and update the user interface data to cause the dialogue string of text to be displayed on the display.

In at least some aspects, the one or more processors configured to update the user interface can be configured to determine one or more updates to the ordered set of images and text objects based on the user input data. The one or more processors can be configured to update the user interface in accordance with the one or more updates to the ordered set of images and text objects.

In some aspects, a method is disclosed. The method can include obtaining, by one or more processing circuits, input data associated with a media instance. The media instance can be associated with a video, a single image, a set of images, a string of text, or combinations thereof, corresponding to a geolocation and/or a travel theme. The method can include providing, by the one or more processing circuits, the media instance as input to a predictive model to cause the predictive model to generate an intermediate set of data objects. The method can include determining, by the one or more processing circuits, a final set of data objects based on the intermediate set of data objects and an inventory database, the final set of data objects including a plurality of data objects maintained in the inventory database and mapped to the intermediate set of data objects. In some examples, the method can include generating, by the one or more processing circuits, user interface data configured to cause a client device having a display to generate a user interface on the display in accordance with the final set of data objects.

In some aspects, obtaining the input data can include establishing, by the one or more processing circuits, a communication connection with the client device in accordance with an application programming interface (API), and obtaining, by the one or more processing circuits, the media instance from the client device or from a service hosting the media instance based on user input received at the client device indicating selection of at least a portion of the media instance.

In some aspects, the predictive model can include a vision language model. Providing the media instance as the input to the predictive model can include generating, by the one or more processing circuits, a tokenized input that is compatible with the vision language model based on the media instance, and providing, by the one or more processing circuits, the tokenized input as the input to the predictive model to cause the predictive model to generate the intermediate set of data objects.

In at least some aspects, the intermediate set of data objects can include a first intermediate set of data objects and the predictive model includes a first predictive model. The method can further include providing, by the one or more processing circuits, the first intermediate set of data objects to a second predictive model to cause the second predictive model to generate a second intermediate set of data objects, each data object of the second intermediate set of data objects including a text string.

In some aspects, the method can further include determining, by the one or more processing circuits, a mapping between the second intermediate set of data objects and elements stored in the inventory database, and determining, by the one or more processing circuits, the final set of data objects based on the mapping.

In at least some aspects, the method can further include generating, by the one or more processing circuits, an ordered set of images and text objects in accordance with a time series, and generating, by the one or more processing circuits, the user interface data in accordance with the ordered set of images and text objects to cause the client device to render a user interface on the display.

In some aspects, the method can further include obtaining, by the one or more processing circuits, one or more device parameters indicating one or more aspects of the display, and generating, by the one or more processing circuits, the user interface data in accordance with the one or more device parameters to cause the ordered set of images and text objects to be displayed according to at least one dimension of the display.

In some aspects, the method can further include obtaining, by the one or more processing circuits, user input data indicating a user interaction with the display, providing, by the one or more processing circuits, the user input data as input to a dialogue system to cause the dialogue system to generate a dialogue string of text, and updating, by the one or more processing circuits, the user interface data to cause the dialogue string of text to be displayed on the display.

In at least some aspects, updating the user interface can include determining, by the one or more processing circuits, one or more updates to the ordered set of images and text objects based on the user input data, and updating, by the one or more processing circuits, the user interface in accordance with the one or more updates to the ordered set of images and text objects.

In yet another embodiment, one or more non-transitory computer-readable mediums having instructions stored thereon are disclosed that, when executed by one or more processors, cause the one or more processors to: obtain input data associated with a media instance, the media instance associated with a video, a single image, a set of images, a string of text, or combinations thereof, corresponding to a geolocation and/or a travel theme. The instructions can cause the one or more processors to provide the media instance as input to a predictive model to cause the predictive model to generate an intermediate set of data objects. The instructions can cause the one or more processors to determine a final set of data objects based on the intermediate set of data objects and an inventory database. The final set of data objects can include a plurality of data objects maintained in the inventory database and mapped to the intermediate set of data objects. The instructions can cause the one or more processors to generate user interface data configured to cause a client device having a display to generate a user interface on the display in accordance with the final set of data objects.

In some aspects, the instructions that cause the one or more processors to obtain the input data can cause the one or more processors to establish a communication connection with the client device in accordance with an application programming interface (API), and obtain the media instance from the client device or from a service hosting the media instance based on user input received at the client device indicating selection of at least a portion of the media instance.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an environment for extracting features from a media instance, according to some implementations;

FIG. 2 is a sequence diagram of an implementation of for extracting features from a media instance, according to some implementations;

FIG. 3 is a flow diagram of a method for extracting features from a media instance, according to some implementations;

FIG. 4 is an example sequence diagram of an environment for extracting features from a media instance, according to some implementations;

The details of various embodiments of the methods and systems are set forth in the accompanying drawings and the description below.

### DETAILED DESCRIPTION

Systems can be configured as described herein to perform one or more operations when for extracting features from a media instance. For example, in some embodiments, a system described herein can first obtain input data associated with a media instance (e.g., an image, a series of images (a video), an audio clip, and/or the like), where the media instance can be linked to a geolocation and/or a travel theme represented in the media instance. The system can then provide the media instance as input to a predictive model (e.g., a vision language model (VLM), a small language model (SLM), a large language model (LLM), etc.) or combination of models to generate an intermediate set of data objects. Using the intermediate set of data objects together with an inventory database, the system can determine a final set of data objects that can include a plurality of data objects maintained in the inventory database and mapped to the intermediate set of data objects. Finally, the system can generate user interface data that causes the client device controlled by the user to present a user interface on a display in accordance with the final set of data objects. As will be understood, the systems and methods described herein can provide multiple advantages when used to generate or update sets of images, particularly when compared to conventional techniques.

For example, the present technology can reduce processing and memory consumption by operating on dense, information-rich media, allowing a predictive model to extract highly discriminative features in a single pass and to generate precise reservation proposals, in some implementations. Increased precision in initial responses can decrease the number of back-and-forth exchanges between a user device and server infrastructure, thereby lowering cumulative computational cycles and memory allocations across the session and accelerating itinerary convergence while maintaining minimal resource overhead. Additionally, delivering an accurately matched itinerary in the initial exchange can dramatically curb network usage because each avoided revision eliminates an additional upload of data (text, media, etc.), a subsequent generation of model embeddings, execution of the model(s) implemented by the system, and a follow-up confirmation. The aggregate reduction in circular traffic can lower bandwidth consumption, diminish congestion on carrier links, and shorten transmission queues, thereby providing a faster and more energy-efficient service footprint. This can allow a user to receive fast itinerary suggestions with fewer interaction steps and reduced battery drain on the client device, thereby improving overall satisfaction and engagement.

The systems and methods described herein can also address technical problems associated with consuming heterogeneous multimodal inputs in a single processing pipeline. In some implementations, platforms may accept structured form inputs and may not be structured to jointly consume video, still images, audio, free-form text, and device- or media-derived metadata (e.g., timestamps, latitude–longitude coordinates, sensor data) within a single downstream model. Example embodiments of the present disclosure can address this technical problem by generating, from a media instance and associated metadata, a tokenized input or embedding compatible with a predictive model and by combining visual descriptors with metadata fields into a representation that the predictive model and/or a downstream language model can jointly process. This can allow a single end-to-end pipeline to extract discriminative features from rich, mixed-modality inputs without requiring users to manually translate such inputs into structured form fields.

The systems and methods described herein can also address technical problems associated with architectural mismatches between models that process visual data and models that perform natural-language reasoning. For example, a single-stage model operating on raw pixel or frame data may produce free-form output while a language model may operate on structured or tokenized inputs to produce natural language outputs, and these different output formats may be difficult to process in a single processing pipeline. Various example embodiments of the present disclosure can address this technical problem by implementing a processing pipeline that includes a predictive model (e.g., a vision language model that processes image, video, and text tokens) configured to generate intermediate data objects and a downstream language model (e.g., an SLM, LLM, or reasoning-based language model) that processes the intermediate data objects to generate final outputs (e.g., itinerary suggestions, etc.). For example, the predictive model implemented in the processing pipeline may be a hierarchical model, which may implement a first model to generate the intermediate data objects identifying travel items associated with a media instance and a second model to generate a second intermediate set of data objects that include structured representations (e.g., text strings, embeddings, etc.) corresponding to the identified travel items. The language model may then consume the structured strings or embeddings produced by the predictive model. Beneficially, this processing pipeline may allow region- or clip-level features to be aggregated into scene-level semantics in a structured form that can be programmatically consumed by one or more downstream computing components. In some implementations, this can allow each model to be independently selected, retrained, scaled, or replaced without disturbing other components of the pipeline.

The systems and methods described herein can also address technical problems associated with aligning outputs of generative models with data maintained in structured, third-party data sources. For example, an output generated by a language model may reference one or more data objects (e.g., travel items). In some implementations, the referenced data objects included in the language model output may not be directly aligned with structured representations or identifiers used by an inventory database maintained by the system or by associated third-party sources, and therefore additional processing may be required to reconcile differences between the generated output and the structured representations, which may increase computational overhead or latency associated with generating the output. One or more embodiments of the present technology can address this technical problem by determining a mapping between intermediate data objects produced by the predictive model and/or language model and elements stored in one or more inventory databases, for example by computing similarity between structured representations of the intermediate data objects and structured representations of inventory entries. One or more embodiments of the present technology can further address this technical problem by merging candidate matches with live availability records and discarding candidates that fail to satisfy temporal or capacity constraints, so that the final set of data objects may correspond to inventory items that are both semantically relevant to the input media and available within the relevant timeframe.

The systems and methods described herein can also address technical problems associated with enforcing safety, compliance, and stylistic constraints on outputs of generative models within a content generation pipeline. In some implementations, application of such constraints may involve processing that is not natively performed by a language model used to generate the content, which may increase processing complexity or require integration of additional computing components associated with performing such processing. One or more embodiments of the present technology can address this technical problem by performing a moderation operation using a policy-tuned language model trained to enforce safety constraints (e.g., filtering or modifying unallowed or unsafe content), compliance constraints (e.g., validating adherence to regulatory or policy requirements), and stylistic guidelines (e.g., modifying generated text to conform to specified tone, structure, and vocabulary constraints) through prompt conditioning, control tokens, fine-tuned model variants, and/or post-processing rules. In some exemplary embodiments, the policy-tuned language model may be separate from the language model that generates the itinerary content, which may allow the moderation operation to be performed independently of content generation to improve the consistency with which the constraints are applied to generated content. Further, such implementations may allow for safety, compliance, and stylistic policies to be updated independently of the content-generation model. In some implementations, the systems and methods described herein may additionally or alternatively fine-tune the content-generation model to enforce such guidelines. For example, the content-generation model may be fine-tuned using the stylistic guidelines, such that the generated output conforms to the associated constraints without requiring separate modification steps. In this way, the system may support multiple configurations for enforcing constraints, including separate moderation components or integrated model behavior, while maintaining flexibility to adapt to different deployment requirements.

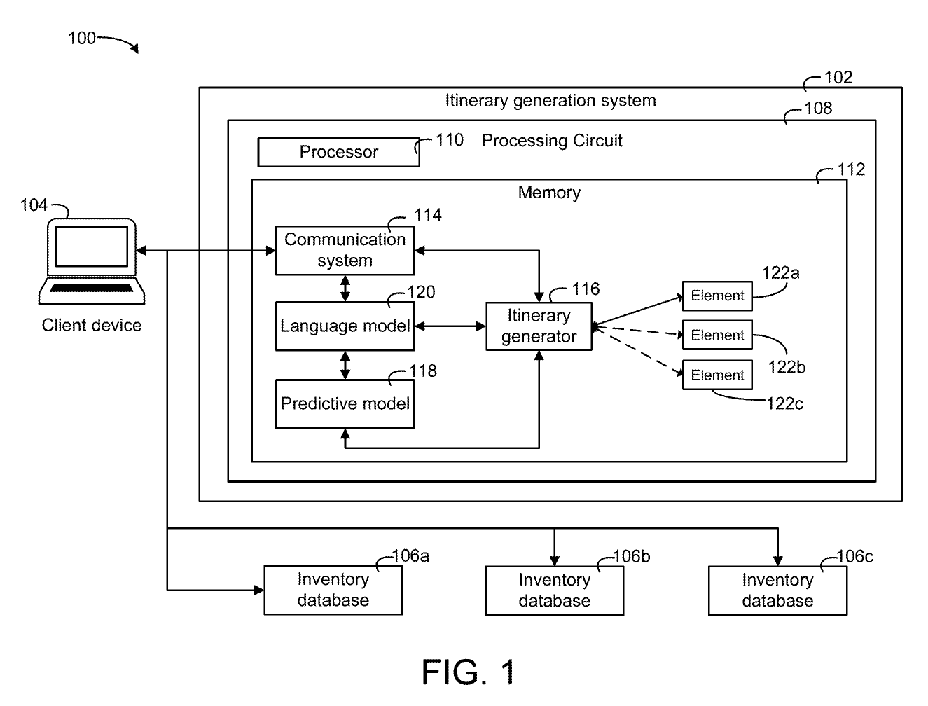

FIG. 1 is a block diagram of an environment 100 for extracting features from a media instance, according to some implementations. The environment 100 can include an itinerary generation system 102, a client device 104, and inventory databases 106a–106c (each referred to individually as inventory database 106 and collectively as inventory databases 106 where contextually appropriate). Various components depicted in FIG. 1 can belong to or otherwise be utilized by an organization involved in generating one or more itineraries such as a travel technology company, etc. The environment 100 is not confined to the components described herein and can include additional or other components, not shown for brevity, which are configured to be considered within the scope of the embodiments described herein. And as noted above, the environment 100 can be used to generate a variety of outputs including images, sets of images, strings of text, etc., that can be configured to be displayed in a particular order to represent a travel itinerary, though the present disclosure is not limited to such examples.

The above mentioned components can be connected to each other through a network (not explicitly illustrated). Examples of the network can include, but are not limited to, public or private local-area-networks (LAN), wireless LAN (WLAN) networks, metropolitan area networks (MAN), wide-area networks (WAN), and the Internet. The network can include wired or wireless communications according to one or more standards or via one or more transport media. The communication over the network can be performed in accordance with various communication protocols such as Transmission Control Protocol and Internet Protocol (TCP/IP), User Datagram Protocol (UDP), and IEEE communication protocols. In one example, the network can include wireless communications according to Bluetooth specification sets or another standard or proprietary wireless communication protocol. In another example, the network can also include communications over a cellular network, including, e.g., a GSM (Global System for Mobile Communications), CDMA (Code Division Multiple Access), and EDGE (Enhanced Data for Global Evolution) network.

The itinerary generation system 102 can be any computing device comprising one or more processors capable of executing the various tasks and processes described herein. For example, the itinerary generation system 102 can include a processing circuit 108 that includes a processor 110. The processor 110 can include one or more various processors such as central processing units (CPUs), graphic processing units (GPUs), combinations thereof, etc. Non-limiting examples of such computing devices can include workstation computers, servers, laptop computers, desktop computers, and/or the like. While the itinerary generation system 102 includes a single processing circuit, the itinerary generation system 102 can include any number of computing devices coordinating operation in a distributed computing environment, such as a cloud environment. The processing circuit 108 can include a memory 112 including one or more non-transitory machine-readable storage mediums. The memory 112 can be associated with a communication system 114, an itinerary generator 116, a predictive model 118, a language model 120, and elements 122a–122c (each referred to individually as an element 122 and collectively as elements 122 where contextually appropriate). While the components of the itinerary generation system 102 are discussed with respect to set of images (e.g., videos), this system can be updated to apply to other modalities other than images or sets of images such as, for example, audio data, text data, sensor data, and combinations thereof. These modalities can be processed using similar principles of deep neural networks as described herein.

In some embodiments, the communication system 114 can be associated with instructions executable by the processor 110. For example, the communication system 114 can be associated with instructions that, when executed by the processor 110, cause the processing circuit 108 to establish one or more communication connections with the client device 104 and/or one or more inventory databases 106 using the network as described herein. These communication connections can be established to allow for the transfer of data to or from the communication system 114 to the client device 104 and/or the inventory databases 106. In some embodiments, the communication system 114 can coordinate operations based on outputs generated by the language model 120. For example, the communication system can coordinate the execution of operations with the language model 120 when generating a user interface at the client device 104. This can allow the communication system 114 to receive outputs from the language model 120, and generate a user interface including a representation of a chatbot at the client device 104 during generation of an itinerary as described herein.

In some embodiments, the itinerary generator 116 can be associated with instructions executable by the processor 110. For example, the itinerary generator 116 can be associated with instructions that, when executed by the processor 110, cause the processing circuit 108 to obtain (e.g., receive, etc.) input data generated at the client device 104, the input data associated with one or more images that are obtained from the client device 104 and/or one or more inventory databases 106. For example, the itinerary generator 116 and can be configured to obtain input data that is associated with one or more images captured or otherwise maintained by a data source, such as an inventory database 106 associated with a social media network, a media distribution network, etc. In examples, the itinerary generator 116 can communicate via the communication system 114 with the client device 104 and/or one or more inventory databases 106 when executing operations to generate or update an itinerary as described herein.

In some embodiments, the predictive model 118 can be associated with instructions executable by the processor 110. For example, the predictive model 118 can be implemented as a vision language model (VLM) that includes a dual-encoder configuration in which a convolutional neural network or a vision transformer processes images or contiguous video frames, while a separate transformer encodes associated text tokens with a shared embedding space allowing cross-modal (e.g., image-text) alignment within a shared latent space. In other examples, the predictive model 118 can include a single-stream transformer that interleaves image patches, video tokens, and text tokens within interconnected self-attention layers, thereby supporting temporal reasoning across frames. In examples, the predictive model 118 can include a hierarchical model that can first use an object-detection backbone or a three-dimensional convolutional network to form region-level or clip-level features, then pass the aggregated descriptors to a multimodal transformer that produces strings of text as output indicating scene-level semantics.

In some embodiments, the predictive model 118 can receive as input one or more still images or video sequences depicting geographic locations, for example a real or virtual environment such as a forest in Norway, together with optional text context (represented using strings) such as a free-form query or metadata tags. The predictive model 118 can be executed based on the input to perform a forward inference pass through the predictive model 118 to generate structured descriptions indicating what is represented in each image or in each video segment, including scene classifications, object inventories, natural-language captions, or bounding boxes around landmarks. Additional outputs can include confidence scores for terrain categories or ordered lists of itinerary suggestions matched to detected points of interest, which the itinerary generator 116 can combine with inventory data to form booking options.

In some embodiments, the itinerary generation system 102 can train or update the predictive model 118 using paired examples of geolocated images or videos and ground-truth textual annotations that specify the depicted scenes, objects, and environmental attributes. During training (or updating), the predictive model 118 can receive input images or video that causes the predictive model 118 to produce descriptions for categorical outputs.

In some embodiments, the language model 120 can be associated with instructions executable by the processor 110. The language model 120 can be implemented as a small language model (SLM), a large language model (LLM), a reasoning-based LLM that supports in-context reasoning, chain-of-thought processing, and tool invocation, etc. In some examples, the language model 120 can implement a decoder-only stack of self-attention and feed-forward layers. In other examples, the language model 120 can include an encoder-decoder arrangement that separates comprehension and generation stages to facilitate multi-turn dialogue. In yet another example, the language model 120 can include a configuration can augment the core transformer with retrieval heads that query the inventory databases 106, allowing the language model 120 to ground textual outputs based on inventory that is available as indicated by the inventory databases 106.

In some embodiments, the language model 120 can receive as input natural-language strings such as user queries, itinerary constraints, or narrative descriptions of geographic media, together with optional structured metadata like timestamps, bounding-box coordinates, or tokenized inputs and/or embeddings produced by the predictive model 118. The language model 120 can implement a forward pass through the language model 120 to cause the language model 120 to output strings of text, step-by-step reasoning traces, or machine-readable objects that enumerate candidate bookings, ranked points of interest, or disambiguated landmark names. The outputs of the language model 120 can include confidence values or chain-of-thought logs that the itinerary generator 116 can use to explain decisions or to select inventory items that satisfy user preferences.

The itinerary generator 116 can obtain the outputs produced by the language model 120, parse textual descriptions, confidence values, and structured objects referencing candidate bookings or points of interest, and optionally query the inventory databases 106 to retrieve corresponding images, video thumbnails, pricing information, and real-time availability data. Using the combined textual and media assets, the itinerary generator 116 can assemble an ordered schedule aligning user preferences with available inventory and can encode the schedule as user interface data formatted for presentation on the client device 104. The itinerary generator 116 can construct a plurality of selectable activities, lodging options, and transportation segments as elements 122, and can attach to each element 122 a media preview, temporal slot, and inventory identifier. The itinerary generator 116 can order the elements 122 based on one or more preferences of the user and/or in accordance with a time series to establish an itinerary. The user interface data can deliver the elements 122 in a scrollable or paginated layout (e.g., for mobile devices) and can cause the client device 104 to render the itinerary for further user refinement or confirmation.

The client device 104 can be any computing device comprising one or more processors capable of executing the various tasks and processes described herein. For example, the client device 104 can include one or more workstation computers, laptop computers, tablets, and/or the like. In operation, various individuals can provide input via one or more input devices of the client device 104 (not explicitly illustrated) to cause the itinerary generation system 102 to generate one or more itineraries as described herein. In some embodiments, the client device 104 can receive input that causes the client device 104 to generate a representation of the itinerary via a display device (not explicitly illustrated).

With continued reference to FIG. 1, one or more components illustrated by FIG. 1 can be configured to obtain data from a client device 104, generate or update itineraries, and generate sets of images in accordance with the output provided by the language model 120. For example, the itinerary generation system 102 can implement the itinerary generator 116 to extract features from media instances obtained from protected networks (e.g., encryption-based network) so that the itinerary generator 116 can generate ordered sets of data objects (representing itineraries) that can be displayed on the client device 104 as user interfaces.

In some embodiments, the itinerary generator 116 can obtain input data associated with a media instance based on data received via the communication system 114. For example, the itinerary generator 116 can obtain the input data, where the input data is associated with a media instance corresponding to a video associated with a geolocation and/or a travel theme (e.g., a European culinary adventure, beach holidays, etc.). In some implementations, the input data may be associated with a travel theme or otherwise include data that can be used to identify a related subject (e.g., food, skiing, golf, hiking, beaches, etc.) and may or may not be associated with a particular geolocation (e.g., may be food associated with a particular geographic region or may be a type of activity or type of environment not specific to a particular geolocation). In examples, the communication system 114 can obtain the media instance in association with a request from the client device 104 or from one or more inventory databases 106. In the latter case, the communication system 114 can obtain the input data from an inventory database 106 associated with a social media website, etc. based on an identifier (e.g., URL, etc.) provided by the client device 104 indicating the location of the input data.

In some embodiments, the communication system 114 can establish a communication connection with the client device 104 in accordance with an application programming interface (API). For example, the communication system 114 can execute one or more operations in accordance with the API to establish a secure (e.g., encrypted, etc.) communication connection with the client device 104. In some examples where the input data includes larger video files that are provided directly by the client device 104, the API can expose a resumable upload endpoint that allows segmented transfer of large video files.

In some embodiments, the communication system 114 can obtain the media instance from the client device 104 or from a service hosting the media instance (implemented by the client device 104 and/or an inventor database 106) based on user input received at the client device 104 indicating selection of at least a portion of the media instance. For example, the client device 104 can stream a uniform resource identifier referencing a network‑hosted video so that redundant data transfer can be avoided. In some examples, the itinerary generator 116 can query the hosting service (e.g., the corresponding inventory database 106) to obtain the input data to be processed as described herein.

In some embodiments, the itinerary generator 116 can generate a embedding based on the input data. For example, the itinerary generator 116 can generate a embedding based on the input data that is compatible with the predictive model 118. In some embodiments, the itinerary generator 116 can provide the input data (e.g., the tokenized input) as an input to the predictive model 118 to cause the predictive model 118 to generate an intermediate set of data objects. For example, the predictive model 118 can be configured to receive the tokenized input and generate strings of text representing the input data as described above. In some examples, the itinerary generator 116 can insert metadata (e.g., a collection timestamp, etc.) into the tokenized input so that the predictive model 118 can further refine the output generated by the predictive model 118. As examples, the predictive model 118 can generate as an output bounding box coordinates and class labels for recognized objects in the input data such as landmarks, etc.

In some embodiments, the itinerary generator 116 can provide the first intermediate set of data objects to the language model 120 (e.g., a second predictive model) so that the language model 120 can generate a second intermediate set of data objects. This second intermediate set of data objects can include a set of one or more text strings. For example, the language model 120 can include a transformer‑based model that is configured to obtain the strings output by the predictive model 118 and execute one or more attention-based operations to generate one or more strings representing natural‑language phrases. These strings output by the language model 120 can then be used to generate a final set of data objects.

In some embodiments, the itinerary generator 116 can determine a mapping between the second intermediate set of data objects and elements stored in the inventory databases 106. For example, the itinerary generator 116 can compute cosine similarity between caption embeddings and inventory title embeddings (e.g., corresponding to hotels, tourist destinations and/or attractions, etc.) stored in the inventory databases 106 where the inventory databases 106 maintain representations of the inventory managed using embeddings (e.g., generated by an encoder of a transformer model as described herein). In other examples, the itinerary generator 116 can determine that one or more portions of the strings output by the language model 120 at least in part matches one or more portions of the strings output by the language model 120. In some examples, a bi‑directional attention layer can refine the mapping by jointly attending to caption words and inventory descriptions.

In some embodiments, the itinerary generator 116 can determine the final set of data objects based on the mapping. For example, the itinerary generator 116 can sort matched inventory elements according to similarity scores and availability constraints indicated by the inventory databases 106. In some examples, the itinerary generator 116 can apply user‑specific preference weights to align the second intermediate set of data objects with the final set of data objects in accordance with previously expressed interests (e.g., from the user operating the client device 104).

In some embodiments, the itinerary generator 116 can determine the final set of data objects based on based on a subset of data objects that are associated with either the geolocation and/or travel theme associated with the input data. For example, the itinerary generator 116 can process the intermediate set of data objects or final set of data objects based on the geolocation and/or travel theme. This can include filtering the intermediate set of data objects or final set of data objects to include only data objects that are associated with the identified geolocation or travel theme. The itinerary generator 116 can then finalize the itinerary to include only data objects that correlate with the geolocation and/or travel theme and generate a user interface to be displayed at the client device 104 as described herein.

In some embodiments, the itinerary generator 116 can determine a final set of data objects (e.g., elements 122a–122c, etc.) based on the intermediate set of data objects stored in the inventory databases 106. For example, the itinerary generator 116 can determine the final set of data objects, where the data objects are associated with a plurality of strings of text, images, etc., that were maintained in the inventory databases 106 and mapped to the intermediate set of data objects. The itinerary generator 116 can then generate user interface data based on the final set of data objects to display the itinerary on a display device of the client device 104.

In some embodiments, the itinerary generator 116 can generate the user interface data to allow the client device 104 to generate a user interface on a display of the client device 104 representing the itinerary. For example, the user interface data can include a structured format (e.g., established using JavaScript Object Notation, etc.) that specifies layout grids, image uniform resource locators, and localized text snippets. The itinerary generator 116 can then use the final set of data objects to generate the user interface data, where the user interface data is configured to control the display device of the client device 104 to generate indications of the elements 122 selected to be provided to the client device 104.

In some embodiments, the itinerary generator 116 can generate the user interface data such that the user interface data includes an ordered set of images and text objects that illustrate an itinerary. For example, the itinerary generator 116 can generate the ordered set of images and text objects in accordance with a time series. This can be based on, for example, the itinerary generator 116 scheduling morning activities before afternoon activities based on local sunrise and sunset times and reservation availability as indicated by the inventory databases 106. In some examples, the images can be resized to multiple aspect ratios so that the client device 104 can choose an optimal representation for portrait or landscape orientations.

In some embodiments, the itinerary generator 116 can generate the user interface data in accordance with the ordered set of images and text objects so that the client device 104 can render a user interface on the display. For example, the itinerary generator 116 can assign grid positions to each image based on the type of screen on which the image will be displayed. This positioning can be to minimize vertical scrolling on small screens, the rendering of large, empty spaces on relatively larger screens, etc. In some examples, the itinerary generator 116 can include animation hints that the client device 104 can interpret to create smooth transitions when users expand an itinerary element (e.g., while scrolling, etc.). In some examples, the itinerary generator 116 can embed style guideline directives specifying typography hierarchies, color palettes, and padding rules so that the client device 104 can apply consistent branding across interface components. In this example, the style guideline directives can include accessibility parameters such as minimum color-contrast ratios and alternative text references to assist screen-reader technologies.

In some embodiments, the itinerary generator 116 can obtain one or more device parameters indicating one or more aspects of the display of the client device 104, such as one or more dimensions of the display. For example, the device parameters can include pixel density, refresh rate, and dimensions associated with a display of the client device 104. In some examples, the communication system 114 can retrieve the device parameters via the communication system 114 from an on‑device configuration profile transmitted by the client device 104 (e.g., when initiating a session). In this example, the itinerary generator 116 can use the device parameters to generate the user interface data and cause the user interface displayed on the client device 104 to be configured in accordance with the one or more aspects of the display of the client device 104. For example, the itinerary generator 116 can choose a higher resolution image set for devices with larger pixel densities. In some examples, the itinerary generator 116 can calculate text line breaks so that captions avoid truncation on narrow displays. In this example, the itinerary generator 116 can adjust touch target sizes to satisfy minimum accessibility thresholds.

In some embodiments, the itinerary generator 116 can obtain user input data indicating a user interaction with the display of the client device 104. For example, the user input data can include an indication of acceptance or non-acceptance of one or more aspects of the itinerary, gesture coordinates indicating a drag action that rearranges itinerary items in the time series, etc. In some examples, the user input data can include an audible input captured by an on‑device microphone. In this example, the communication system 114 can packetize the audible input to generate a transcript and forward the transcript to the itinerary generator 116 for downstream processing. This downstream processing can include re-executing the predictive model 118 and/or the language model 120 as described above.

In some embodiments, the itinerary generator 116 can provide the user input data as input to a dialogue system (e.g., the language model 120, a conversational agent implemented by the itinerary generator 116, etc.) so that the dialogue system can generate a dialogue string of text. For example, the dialogue system can parse the user input data to identify intent related to modifying lodging options. In some examples, the dialogue system can reference a knowledge base to incorporate pricing constraints into the generated dialogue string. In this example, the itinerary generator 116 can append a unique identifier to the dialogue string so that subsequent user responses can maintain conversational context.

In some embodiments, the itinerary generator 116 can update the user interface data so that the dialogue string of text can be displayed on the display of the client device 104. For example, the updated user interface data can allocate a portion of the user interface (e.g., a lower portion, etc.) to include a chat box that is usable to provide feedback and update the itinerary represented by the user interface. In some examples, the itinerary generator 116 can stream incremental tokens from the dialogue system to the client device 104 so that a user perceives near-real-time conversational feedback. In this example, the user can submit follow-up text or voice commands through the chat box, and the itinerary generator 116 can route the commands to the dialogue system to derive updated intent representations. For example, upon detecting an intent requesting additional sightseeing options, the itinerary generator 116 can re-invoke the predictive model 118 to analyze supplemental video frames and can call the language model 120 to synthesize an itinerary narrative based on the new analysis. In at least some examples, the itinerary generator 116 can repeat an invocation loop alternating between the predictive model 118 and the language model 120 after each user interaction until the user indicates acceptance, thereby allowing convergence toward a finalized itinerary aligned with expressed preferences and inventory constraints.

In some embodiments, the itinerary generator 116 can be configured to update the user interface can determine one or more updates to the ordered set of images and text objects based on the user input data. For example, the itinerary generator 116 can update a museum visit with an outdoor activity after detecting a preference change expressed in the dialogue string. In some examples, the itinerary generator can verify that updated travel times remain within feasible bounds given public transit schedules. In this example, the itinerary generator 116 can recalculate distance metrics using a geographic information system service to reflect the revised order.

In some embodiments, the itinerary generator 116 can update the user interface in accordance with the one or more updates to the ordered set of images and text objects. For example, the update the user interface to change the affected itinerary tiles. In some examples, the itinerary generator 116 can updates to the client device 104 so that only changed portions of the user interface require re‑rendering on the client device 104. In this example, the itinerary generator 116 can log a version number for each revision so that an undo stack can be constructed if the user requests a rollback.

In some embodiments, the itinerary generator 116 can receive an indication generated based on input at the client device 104 that an itinerary is accepted and can proceed to book reservations based on the itinerary. For example, the client device 104 can transmit a signed payload established based on the secured communication connection that includes an itinerary identifier, a payment authorization token, and user credentials confirming acceptance. In some examples, the communication system 114 can authenticate the signed payload and route the authenticated payload to the itinerary generator 116. In this example, the itinerary generator 116 can query the inventory database 106 for each element 122 to acquire current availability data, invoke supplier APIs to reserve the inventory items, and finalize reservation records upon successful payment authorization.

In some embodiments, the itinerary generator 116 can generate confirmation data objects after successful reservation booking and can send the confirmation data objects to the client device 104. For example, the confirmation data objects can include reservation numbers, check‑in instructions, digital tickets, and calendar files formatted as calendar attachments. In some examples, the communication system 114 can deliver the confirmation data objects via a push‑notification channel for immediate in‑app display or system notification and can additionally transmit an email fallback containing the same information. In this example, the itinerary generator 116 can embed a version identifier in each confirmation data object so that any subsequent itinerary modification can reference a baseline when rendering updated confirmations on the client device 104.

As will be understood, in addition to the above-described benefits achieved through implementation of the systems and methods described, the overall experience of users controlling the client device 104 can be improved, resulting in improved customer conversion. For example, by reducing the amount of back-and-forth updates that are involved in conventional itinerary generation, the corresponding fatigue experienced by individuals operating the client device 104 can be significantly reduced. And by delivering personalized content in real time the itinerary generator 116 can dynamically adjust the user interface to minimize perceived latency and prevent decision paralysis.

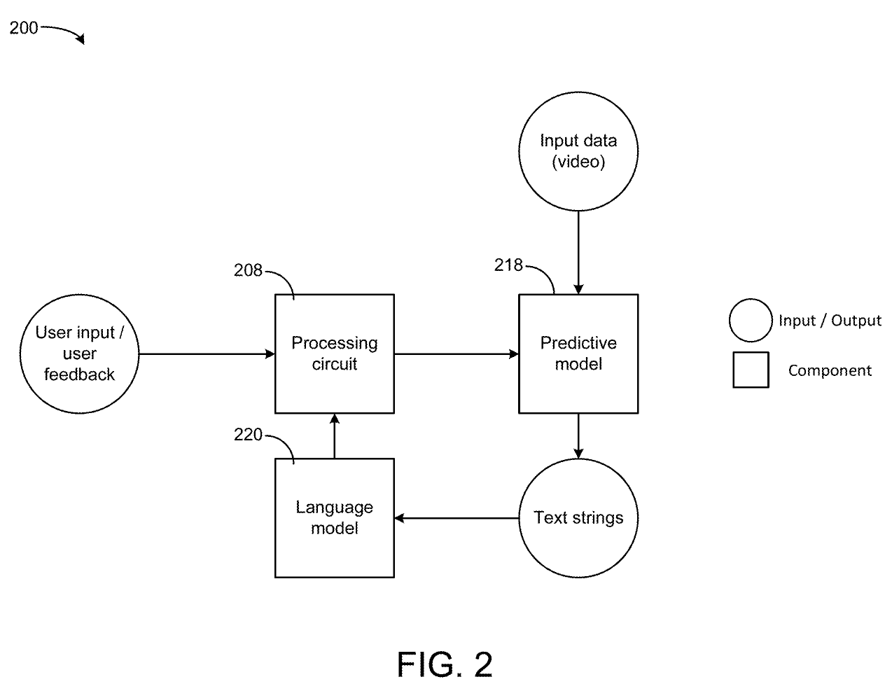

FIG. 2 is a sequence diagram of an implementation 200 of extracting features from a media instance, according to some implementations. In some examples, one or more aspects described herein with respect to implementation 200 can be performed by, and can be the same as or similar to, operations performed by one or more devices of FIG. 1. This can include the operations performed by the itinerary generator 116, the predictive model 118, and/or the language model 120 as described herein.

In some embodiments, an itinerary generator (e.g., that is the same as, or similar to, the itinerary generator 116 of FIG. 1) can be implemented by a processing circuit 208 (e.g., that is the same as, or similar to, the processing circuit 108 of FIG. 1) to receive user input at a first point in time. For example, the user input can request generation of an itinerary based on a set of images such as a video short depicting individuals hiking in a first location (e.g., near city in a country) and visiting a historical site in the first location. In some examples, the itinerary generator can provide the input data corresponding to the user input to a predictive model 218 (e.g., that is the same as, or similar to, the predictive model 118 of FIG. 1). For example, the itinerary generator can cause the input data to be provided to the predictive model 218 to cause the predictive model 218 to process the input data. This can cause the predictive model 218 to generate a set of strings representing scenes included or represented by the input data. The itinerary generator can then cause the text strings output by the predictive model 218 to be provided to a language model 220 (e.g., that is the same as, or similar to, the language model 120 of FIG. 1). The language model can then execute one or more operations to generate an itinerary based on the set of strings generated by the predictive model 218.

In some embodiments, the itinerary generator can obtain the itinerary generated by the language model 220 and can initiate an iterative refinement loop that alternates between the predictive model 218 and the language model 220. For example, the itinerary generator can present the itinerary on a display of a client device (e.g., that is the same as, or similar to, the client device 104 of FIG. 1) and can receive user feedback indicating that additional outdoor activities should be included during an afternoon time slot. In some examples, the itinerary generator can convert the user feedback into an updated tokenized input and can re-invoke the predictive model 218 to update the itinerary. In this example, the predictive model 218 can output supplemental text strings that the language model 220 can merge with the original itinerary constraints to form an updated itinerary draft. In some examples, the itinerary generator can repeat the refinement loop until the user confirms acceptance. The itinerary generator can then execute one or more operations to generate reservations in accordance with the itinerary and send a confirmation to the client device indicating that the reservations were successfully made.

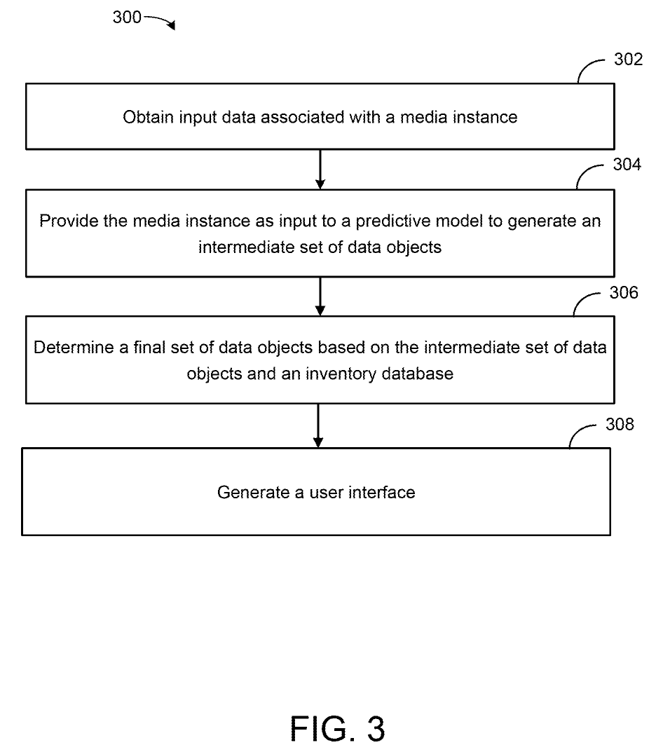

FIG. 3 is a flow diagram of a method 300 for extracting features from a media instance, according to some implementations. The method 300 includes operations 302–308. However, other embodiments can include additional or alternative operations or can omit one or more operations altogether. The method 300 is described as being executed by an itinerary generation system which can be the same as, or similar to, the itinerary generation system 102 described in FIG. 1. However, one or more steps of the method 300 can be executed by any number of computing devices operating in the distributed computing system described in FIG. 1. For instance, one or more computing devices can locally perform part or all of the operations described.

At operation 302, input data associated with a media instance may be obtained. For example, the itinerary generation system 102 may obtain the input data via the communication system 114, in some implementations. The media instance may be associated with a video, a single image, a set of images, a string of text, or combinations thereof. For example, the itinerary generation system 102 can establish a secured communication connection with a client device (e.g., client device 104) and can receive the media instance (e.g., as a sequence of fragmented segments such as images forming a video stream). In some embodiments, establishing the secured connection may include interfacing with an application programming interface (API) associated with the client device 104 or a third-party service hosting the media instance, and obtaining the media instance from the client device 104 or from the third-party service based on user input received at the client device 104 indicating a selection of at least a portion of the media instance. For example, the user input may be a selection of an icon, link, or other selectable element displayed in association with a post on a social messaging platform. Such user input may trigger transmission of a request via the API to the itinerary generation system 102 to obtain the input data corresponding to the selected media instance or portion thereof. In other embodiments, the media instance may be directly uploaded from the client device 104 to the itinerary generation system 102.

In some examples, the itinerary generation system 102 can enrich each segment with auxiliary metadata including timestamps, latitude–longitude coordinates, etc., associated with the client device or the media instance before processing the input data. For example, metadata obtained from the client device 104 (e.g., GPS data, device sensor data, or user profile information) may be used to determine a geolocation of the user, which may then be used to tailor itinerary recommendations to the user’s current location. Additionally or alternatively, metadata associated with the media instance may be used to determine a geolocation of the media instance itself. For example, the itinerary generation system 102 may analyze or otherwise process the media instance metadata to determine a location of a travel item represented by the media instance. Additionally or alternatively, the media instance metadata may be analyzed to associate the input data with a travel theme (e.g., adventure travel, culinary experiences, cultural tourism, etc.).

At operation 304, an intermediate set of data objects may be generated. More specifically, the itinerary generation system 102 (e.g., using the itinerary generator 116) can provide the media instance as input to a predictive model (e.g., predictive model 118 or predictive model 218) to generate an intermediate set of data objects. For example, the itinerary generation system 102 can generate an embedding representing a multi‑dimensional array of numerical feature representations corresponding to a plurality of visual, textual, and/or contextual attributes of the media instance. The plurality of attributes may include pixel data, detected objects, and/or semantic features extracted from the media instance, among other attributes. In some embodiments, the itinerary generation system 102 may generate the multi-dimensional array by applying one or more feature extraction models (e.g., convolutional neural networks, transformers, encoders, etc.) to encode the media instance into a latent feature space. Upon generation of the embedding, the itinerary generation system 102 can transmit the embedding to the predictive model 118 (e.g., a VLM). As described herein with reference to FIGS. 1 and 2, the itinerary generation system 102 may generate a tokenized input compatible with the predictive model 118 based on the media instance, in some implementations. Therefore, the predictive model 118 may generate the intermediate set of objects based on the tokenized input. In this example, the predictive model 118 can output a set of strings indicating travel items illustrated by the input data. The travel items may be or include landmarks, points of interest, activities, venues, geographic locations, hotels or rental properties, or other travel-related entities.

As described herein with reference to FIG. 1, some implementations of the predictive model 118 may be a hierarchical model. Therefore, operation 304 may include implementing a first predictive model (e.g., an object detection backbone, three-dimensional convolutional neural network, etc.) to generate a first intermediate set of data objects including region-level or clip-level features. The first intermediate set of data objects may then be passed to a second predictive model (e.g., one or more multimodal transformers, etc.) to generate a second intermediate set of data objects that include text strings corresponding to identified travel items. The itinerary generation system 102 can then cause the set of strings to be provided to a language model (e.g., language model 120 or language model 220) (e.g., an LLM, SLM, reasoning-based language model, etc.) to cause the language model 120 to process the set of strings in accordance with available inventory as indicated by one or more inventory databases. For example, the language model 120 may determine a mapping between the text strings (e.g., the second set of intermediate data objects) and elements stored in the one or more inventory databases, such as lodging accommodations, activities, dining options, or transportation services.

At operation 306, a final set of data objects may be determined. More specifically, the itinerary generation system 102 (e.g., using the itinerary generator 116) can determine the final set of data objects based on the intermediate set of data objects and one or more inventory databases (e.g., inventory databases 106). For example, the itinerary generation system 102 can merge candidate matches with live availability records and can discard entries that one or more limits. The candidate matches may include potential inventory items identified by the language model 120 based on mappings between the intermediate set of data objects and the elements stored in the one or more inventory databases 106. The live availability records may include real-time or near real-time data associated with the candidate matches, such as current booking availability, pricing, operating hours, or capacity constraints associated with the candidate matches. The live availability records may be retrieved from the one or more inventory databases 106 or from one or more associated service providers.

The one or more limits may be constraints that define whether a candidate match can feasibly be included in an itinerary. These limits may include temporal constraints (e.g., availability within specified dates or times, alignment with scheduled itinerary slots, minimum or maximum durations, compatibility with transit times between locations, etc.) and capacity constraints (e.g., availability of reservations, remaining inventory units such as hotel rooms or tour slots, maximum occupancy limits, ticket availability for events, etc.). For example, a candidate match may be excluded if a restaurant is closed during a scheduled meal time or date, if a tour is fully booked during the scheduled timeframe, or if a hotel has no available rooms for the selected travel dates. These limits may be derived from information associated with the itinerary (e.g., user-specified or inferred travel dates, etc.), from constraints included in the live availability records (e.g., operating hours, reservation windows, capacity limits, etc.), and/or from system-defined rules (e.g., minimum buffer times between activities, itinerary feasibility constraints, etc.). Additionally or alternatively, the limits may be explicitly included in the data retrieved from the inventory databases 106 or provided via APIs associated with the service providers.

The final set of data objects may be or include a plurality of data objects maintained in the inventory databases 106 and mapped to the intermediate set of data objects. In some embodiments, the itinerary generation system 102 may determine the final set of data objects based at least in part on information included in the input data. For example, operation 306 may include determining the final set of data objects by filtering the candidate matches based on a geolocation associated with the input data, such that the final set of data objects correspond to inventory items located within a geographic region associated with the geolocation. Additionally or alternatively, operation 306 may include determining the final set of data objects by filtering the candidate matches based on a travel theme associated with the input data, such that the final set of data objects correspond to inventory items associated with one or more theme classifications (e.g., adventure, culinary, luxury travel, etc.).

In this example, the itinerary generation system 102 can apply user preference weights to determine the final set of data objects that each indicate portions of an itinerary to be displayed to the user controlling the client device 104. In some embodiments, the itinerary generation system 102 may derive the user preference weights based on historical user behavior (e.g., prior selections, browsing history, interaction patterns, etc.) and/or stored user profiles. For example, the itinerary generation system 102 may assign relative weights to the candidate matches based on inferred user preferences (e.g., budget ranges, preferred accommodation types, preferred activity categories, etc.), and may rank or select the final set of data objects based on the applied weights. Additionally or alternatively, the user preference weights may be derived from explicit user preferences. For example, the itinerary generation system 102 may receive user-specific inputs via the client device 104 (e.g., selected filters, selected activity types, excluded categories, etc.), and may assign or adjust the user preference weights based on the received inputs to prioritize the candidate matches that satisfy the explicitly indicated preferences.

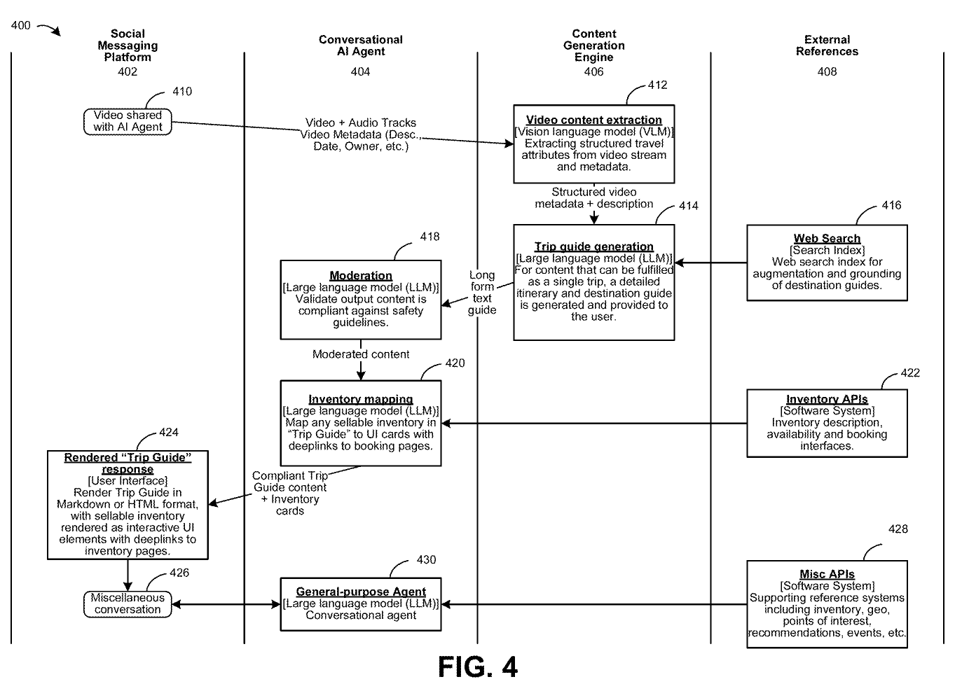

At operation 308, the itinerary generation system 102 can generate a user interface. For example, the itinerary generation system 102 (e.g., using the itinerary generator 116) can generate user interface data based on the final set of data objects for display on a display device of the client device 104. In some examples, the user interface data can define interactive elements that allow a user to vertically scroll through itinerary items, invoke feedback controls to modify one or more elements of the itinerary (e.g., change the times of appointments, hotel selections, etc.), and provide a confirmation to approve or decline the finalized itinerary. In some embodiments, the user interface may be provided as part of a conversational interface, such as a chatbot, configured to present the itinerary items and receive natural language inputs from the user to revise the itinerary. For example, the chatbot may present a set of hotel options and subsequently receive a user input such as “can you show me 3-star hotels?”. In response, the itinerary generation system 102 may update the final set of data objects by re-performing one or more operations of the method 300 based on the updated user input, and may regenerate the user interface data accordingly. Various operations performed by the itinerary generation system 102 to generate the user interface and update the user interface based on user inputs are described in greater detail herein with reference to at least FIG. 4.

FIG. 4 is a sequence diagram of an environment 400 for extracting features from a media instance, according to some implementations. One or more aspects described herein with respect to the environment 400 can be performed by one or more devices of FIG. 1. In some embodiments, the environment 400 includes a social messaging platform 402, a conversational AI agent 404 (e.g., that can be implemented by the itinerary generation system 102), a content generation engine 406 (e.g., that can be implemented by the itinerary generation system 102 and can be the same as, or similar to, the itinerary generator 116 of FIG. 1), and external references 408 (e.g., that can be the same as, or similar to, the inventory databases 106 of FIG. 1).

In some embodiments, a social messaging platform 402 can initiate a workflow by transmitting input data including or indicating images, video, etc. associated with the social media platform 402 to a conversational AI agent 404 (block 410). For example, the social messaging platform 402 can receive a user‑captured travel video and can stream the video frames, accompanying audio tracks, and associated metadata fields, such as a textual description, a capture date, and an owner identifier, over a secure channel to the conversational AI agent 404.

In some embodiments, upon receiving the media payload, the content generation engine 406 can execute a video‑content‑extraction operation (block 412). The video-content-extraction operation may be performed in the same or similar manner as operations 302 and 304 of the method 300. For example, the content generation engine 406 can execute a VLM (e.g., predictive model 118 or predictive model 218) that parses the video stream, extracts frame‑level features, and generates sets of strings (e.g., structured descriptors) indicating detected landmarks, weather conditions, and activity labels. In some examples, the content generation engine 406 can fuse the visual descriptors with the metadata fields forwarded by the conversational AI agent 404 to create a unified representation input data.

In some embodiments, the content generation engine 406 can perform a trip‑guide‑generation operation (block 414) that uses a language model (e.g., language model 120 or language model 220) (e.g., an SLM, LLM, reasoning-based language model, etc.) to transform the structured metadata object into an itinerary (e.g., a long‑form destination guide). For example, the LLM can generate an itinerary that represents transportation suggestions, lodging options, and points of interest derived from the previously extracted landmarks. In some examples, the content generation engine 406 can enforce stylistic guidelines (e.g., tone, sentence length, and branding vocabulary) while generating the itinerary to match organizational standards established for the content generation engine 406. The stylistic guidelines may be rules or constraints that define desired characteristics of generated content. The stylistic guidelines may include tone (e.g., formal, conversational, etc.), structural requirements (e.g., sentence length, paragraph organization, etc.), formatting conventions, among other guidelines. For example, the stylistic guidelines may specify that itineraries use concise sentences or include headings for each day of travel. In some embodiments, the stylistic guidelines may be obtained from predefined templates, configuration files, or content policy repositories associated with the content generation engine 406. In some embodiments, the content generation engine 406 may enforce the stylistic guidelines by conditioning the language model with prompts or control tokens that encode the guidelines, by utilizing a fine-tuned version of the language model trained on guideline-compliant data, and/or by applying post-processing rules that modify generated text to conform to the specified tone, structure, and vocabulary constraints. Additionally or alternatively, the content generation engine 406 may implement a separate fine-tuned language model to process the itinerary content in accordance with the stylistic guidelines.

In some embodiments, the content generation engine 406 can update the itinerary based on external references 408 obtained based on a web‑search request (block 416). For example, the content generation engine 406 can process a search index for articles, visitor reviews, and geospatial facts for the itinerary. In some embodiments, the content generation engine 406 may trigger the web-search request in response to determining that additional contextual information is needed to validate or supplement portions of the itinerary. The web-search request may be executed via one or more APIs that interface with one or more external search services, content providers, or other data sources. In some examples, the content generation engine 406 can rank the external references 408 based on their relevance to the itinerary and update the itinerary to include the external references 408 that are more relevant than other external references 408.

In some embodiments, the conversational AI agent 404 can perform a moderation operation (block 418) that validates the contents of the itinerary against predefined safety and compliance guidelines. For example, the conversational AI agent 404 can execute a policy‑tuned LLM to process the draft itinerary content that is not permitted for the itinerary (e.g., disallowed language, incorrect health advisories, culturally sensitive references, etc.). The policy-tuned LLM may be a different LLM than the language model implemented at block 414. Additionally or alternatively, the content generation engine 406 may enforce the safety and compliance guidelines by conditioning or fine-tuning the language model implemented at block 414 using guideline compliant data. In this example, the conversational AI agent 404 can generate a moderated version of the itinerary. The safety and compliance guidelines may include rules or constraints governing permissible content. For example, the guidelines may be or include restrictions on inappropriate or offensive language, requirements for accurate and up-to-date travel information, avoidance of culturally sensitive or misleading statements, adherence to legal or regulatory requirements applicable to travel content, and so on. As a non-limiting example, the guidelines may restrict inclusion of unsafe travel recommendations in view of known safety risks or travel advisories. In some embodiments, the safety and compliance guidelines may be retrieved from one or more policy repositories maintained by the environment 400.

In some embodiments, the conversational AI agent 404 can execute an inventory‑mapping operation (block 420) that aligns portions of the itinerary with inventory items maintained by inventory databases. For example, the conversational AI agent 404 can extract entity names (e.g., hotel properties, excursion operators, etc.) from the moderated narrative and can generate embeddings for each entity. In some examples, the conversational AI agent 404 can compare the embeddings with catalog embeddings stored in an inventory database 106 to identify matching inventory identifiers, availability statuses, and pricing details. In this example, the conversational AI agent 404 can include the matched inventory identifiers in the itinerary. In some embodiments, the inventory-mapping operation may be performed in the same or similar manner as operations 304 and 306 of the method 300.

In some embodiments, to confirm availability and to lock prices, the conversational AI agent 404 can interact with inventory application programming interfaces (block 422) accessible by external references 408. For example, the conversational AI agent 404 can call booking endpoints for lodging, transportation, or activity suppliers and can retrieve confirmation codes and cancellation policies. In some examples, the conversational AI agent 404 can cache the supplier responses in a short‑lived datastore so that subsequent user interactions can proceed without redundant network latency. In this example, the conversational AI agent 404 can represent the supplier responses in the itinerary inventory data using the content generation engine 406.

In some embodiments, the content generation engine 406 can assemble the itinerary into a user interface representing, e.g., a trip‑guide for presentation within the social messaging platform 402 (block 424). For example, the content generation engine 406 can transform the markdown text and embedded inventory widgets into HTML fragments that include links associated with supplier booking pages. In some examples, the content generation engine 406 can optimize image assets referenced in the guide for the target display density of the client device that generated the request for the itinerary. In this example, the content generation engine 406 can deliver the itinerary to the social messaging platform 402, which can display a user interface representing the itinerary. This can be as part of an interactive message in the user’s chat thread. As described herein with reference to at least FIG. 1, the user interface may be assembled in accordance with one or more aspects of the display of the client device 104 accessing the social messaging platform 402. The device parameters may be received or obtained from an on‑device configuration profile transmitted by the client device 104, and the content generation engine 406 can use the device parameters to generate the user interface data and cause the user interface displayed on the client device 104 to be configured in accordance with the one or more aspects of the display of the client device 104.

In some embodiments, after delivering the trip guide, the social messaging platform 402 can facilitate miscellaneous conversation (block 426) with the user while maintaining the same session context. For example, the user can ask clarifying questions, request substitutions, or share the itinerary with additional chat participants, and the social messaging platform 402 can capture each message and forward it to the conversational AI agent 404 to be used when updating the itinerary. In some examples, the social messaging platform 402 can tag each input with a correlation identifier that allows the conversational AI agent 404 to update or branch the itinerary accordingly.

In some embodiments, the conversational AI agent 404 can call miscellaneous application programming interfaces (block 428) within external references 408 to supplement the dialogue with auxiliary data. For example, the conversational AI agent 404 can query a weather‑forecast service, a local‑events calendar, or a public‑transit scheduler to answer user follow‑up questions. In some examples, the conversational AI agent 404 can merge the retrieved auxiliary data into the existing itinerary, automatically adjusting activity timing or travel routes in accordance with the auxiliary data. In this example, the conversational AI agent 404 can return the updated details to the content generation engine 406.

In some embodiments, the conversational AI agent 404 can implement a general‑purpose agent module (block 430) implemented as an LLM to sustain open‑ended dialogue with the user through the social messaging platform 402. For example, a general‑purpose agent can interpret user sentiments, manage conversational memory, and orchestrate calls to specialized sub‑agents (e.g., the moderation or inventory‑mapping modules, etc.) based on detected intents. In some examples, the general‑purpose agent can summarize multi‑turn discussions into compact state vectors that allow quick context restoration after periods of inactivity. In this example, the general‑purpose agent can signal completion when the user approves the finalized itinerary, thereby triggering downstream reservation booking workflows within the inventory systems.

The arrangement, construction, and description of the systems and methods as shown in the various examples are illustrative only. While some examples have been described herein, several modifications and/or adjustments are possible (e.g., variations in sizes, dimensions, structures, shapes, and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions, and arrangement of the embodiments without departing from the scope of the present disclosure.

The present disclosure contemplates methods, systems, and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

As used herein, an element or step recited in the singular and proceeded with the word “a” or “an” should be understood as not excluding plural elements or steps, unless such exclusion is explicitly recited. Furthermore, references to “exemplary embodiment,” “example embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed as means-plus-function elements (e.g., under 35 U.S.C. § 112(f)) unless “means for” or “step for” is expressly recited in the claim(s).

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

Conditional language used herein, such as, among others, "can," "could," "might," "may," “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

It may be understood by those within the art that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to," etc.). It may be further understood by those within the art that if a specific number of an introduced claim recitation is intended, such an intent may be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to inventions containing only one such recitation, even when the same claim includes the introductory phrases "one or more" or "at least one" and indefinite articles such as "a" or "an" (e.g., "a" and/or "an" should typically be interpreted to mean "at least one" or "one or more"); the same holds true for the use of definite articles used to introduce claim recitations. In addition, even if a specific number of an introduced claim recitation is explicitly recited, those skilled in the art may recognize that such recitation should typically be interpreted to mean at least the recited number (e.g., the bare recitation of "two recitations," without other modifiers, typically means at least two recitations, or two or more recitations). Furthermore, in those instances where a convention analogous to "at least one of A, B, and C" is used, or “at least one of A, B, or C” is used, in both cases such usage should be interpreted as covering any permutation of A, B, or C, alone or in combination, unless expressly indicated otherwise (e.g., "a system having at least one of A, B, and C" would include systems that have A alone, B alone, C alone, A and B together, A and C together, B and C together, and A, B, and C together). It may be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" may be understood to include the possibilities of "A" or "B" or "A and B." Further, the use of the words “approximate,” “about,” “around,” “substantially,” etc., may mean plus or minus ten percent, in some implementations.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

As used herein, the terms “optimize,” “optimization,” and similar expressions are not intended to require that the referenced feature, parameter, or process be made perfect, ideal, or maximized to its theoretical limit. Rather, such terms should be understood to encompass any degree of improvement in performance, efficiency, effectiveness, cost, or other relevant characteristic, whether marginal or substantial, and whether or not the improvement achieves a maximum possible value. Accordingly, an “optimized” result or step may represent an enhancement relative to a baseline or prior state, without implying that no further improvement is possible.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

As used herein, unless specifically indicated otherwise, the term "circuit" includes implementations in which the features and/or functionality are provided via: (1) instructions stored on a computer-readable storage medium (e.g., memory) that are executable by a processor, (2) general purpose or special purpose hardware, or (3) a combination thereof.

What is claimed is:

1. A system for extracting features from media instances obtained from protected networks to generate ordered sets of data objects configured to generate user interfaces, the system comprising:
one or more memories storing instructions thereon that, when executed by one or more processors, cause the one or more processors to:
obtain input data associated with a media instance, the media instance associated with a video, a single image, a set of images, a string of text, or combinations thereof;
provide the media instance as input to a predictive model to cause the predictive model to generate an intermediate set of data objects;
determine a final set of data objects based on the intermediate set of data objects and an inventory database, the final set of data objects comprising a plurality of data objects maintained in the inventory database and mapped to the intermediate set of data objects; and
generate user interface data configured to cause a client device having a display to generate a user interface on the display in accordance with the final set of data objects.

2. The system of claim 1, wherein the input data is associated with a geolocation,
wherein determining the final set of data objects comprises:
determining a subset of data objects maintained in the inventory database that correspond to the geolocation; and
determining the final set of data objects based on the subset of data objects maintained in the inventory database.

3. The system of claim 1, wherein the input data is associated with a travel theme,
wherein determining the final set of data objects comprises:
determining a subset of data objects maintained in the inventory database that correspond to the travel theme; and
determining the final set of data objects based on the subset of data objects maintained in the inventory database.

4. The system of claim 1, wherein the one or more processors configured to obtain the input data are configured to:
establish a communication connection with the client device in accordance with an application programming interface (API); and
obtain the media instance from the client device or from a service hosting the media instance based on user input received at the client device indicating selection of at least a portion of the media instance.

5. The system of claim 1, wherein the predictive model comprises a vision language model,
wherein the one or more processors configured to provide the media instance as the input to the predictive model are configured to:
generate a tokenized input that is compatible with the vision language model based on the media instance; and
provide the tokenized input as the input to the predictive model to cause the predictive model to generate the intermediate set of data objects.

6. The system of claim 1, wherein the intermediate set of data objects comprises a first intermediate set of data objects and the predictive model comprises a first predictive model, the one or more processors further configured to:
provide the first intermediate set of data objects to a second predictive model to cause the second predictive model to generate a second intermediate set of data objects, each data object of the second intermediate set of data objects comprising a text string.

7. The system of claim 6, wherein the one or more processors are further configured to:
determine a mapping between the second intermediate set of data objects and elements stored in the inventory database; and
determine the final set of data objects based on the mapping.

8. The system of claim 1, wherein the one or more processors configured to generate the user interface data are configured to:
generate an ordered set of images and text objects, where the text objects are ordered in accordance with a time series; and
generate the user interface data in accordance with the ordered set of images and text objects to cause the client device to render a user interface on the display.

9. The system of claim 1, wherein the one or more processors are further configured to:
obtain one or more device parameters indicating one or more aspects of the display;
generate an ordered set of images and text objects, wherein the text objects are ordered in accordance with a time series; and
generate the user interface data in accordance with the one or more device parameters to cause the ordered set of images and text objects to be displayed according to at least one dimension of the display.

10. The system of claim 9, wherein the one or more processors are further configured to:
obtain user input data indicating a user interaction with the display;
determine one or more updates to the ordered set of images and text objects based on the user input data; and
update the user interface in accordance with the one or more updates to the ordered set of images and text objects.

11. The system of claim 1, wherein the one or more processors are further configured to:
obtain user input data indicating a user interaction with the display;
provide the user input data as input to a dialogue system to cause the dialogue system to generate a dialogue string of text; and
update the user interface data to cause the dialogue string of text to be displayed on the display.

12. A method comprising:
obtaining, by one or more processing circuits, input data associated with a media instance, the media instance associated with a video, a single image, a set of images, a string of text, or combinations thereof corresponding to a geolocation;
providing, by the one or more processing circuits, the media instance as input to a predictive model to cause the predictive model to generate an intermediate set of data objects;
determining, by the one or more processing circuits, a final set of data objects based on the intermediate set of data objects and an inventory database, the final set of data objects comprising a plurality of data objects maintained in the inventory database and mapped to the intermediate set of data objects; and
generating, by the one or more processing circuits, user interface data configured to cause a client device having a display to generate a user interface on the display in accordance with the final set of data objects.

13. The method of claim 12, wherein obtaining the input data comprises:
establishing, by the one or more processing circuits, a communication connection with the client device in accordance with an application programming interface (API); and
obtaining, by the one or more processing circuits, the media instance from the client device or from a service hosting the media instance based on user input received at the client device indicating selection of at least a portion of the media instance.

14. The method of claim 12, wherein the predictive model comprises a vision language model,
wherein providing the media instance as the input to the predictive model comprises:
generating, by the one or more processing circuits, a tokenized input that is compatible with the vision language model based on the media instance; and
providing, by the one or more processing circuits, the tokenized input as the input to the predictive model to cause the predictive model to generate the intermediate set of data objects.

15. The method of claim 12, wherein the intermediate set of data objects comprises a first intermediate set of data objects and the predictive model comprises a first predictive model, the method further comprising:
providing, by the one or more processing circuits, the first intermediate set of data objects to a second predictive model to cause the second predictive model to generate a second intermediate set of data objects, each data object of the second intermediate set of data objects comprising a text string.

16. The method of claim 15, further comprising:
determining, by the one or more processing circuits, a mapping between the second intermediate set of data objects and elements stored in the inventory database; and
determining, by the one or more processing circuits, the final set of data objects based on the mapping.

17. The method of claim 13, further comprising:
generating, by the one or more processing circuits, an ordered set of images and text objects, where the text objects are ordered in accordance with a time series; and
generating, by the one or more processing circuits, the user interface data in accordance with the ordered set of images and text objects to cause the client device to render a user interface on the display.

18. The method of claim 17, further comprising:
obtaining, by the one or more processing circuits, user input data indicating a user interaction with the display;
providing, by the one or more processing circuits, the user input data as input to a dialogue system to cause the dialogue system to generate a dialogue string of text; and
updating, by the one or more processing circuits, the user interface data to cause the dialogue string of text to be displayed on the display.

19. The method of claim 18, wherein updating the user interface comprises:
determining, by the one or more processing circuits, one or more updates to the ordered set of images and text objects based on the user input data; and
updating, by the one or more processing circuits, the user interface in accordance with the one or more updates to the ordered set of images and text objects.

20. One or more non-transitory computer-readable mediums having instructions stored thereon that, when executed by one or more processors, cause the one or more processors to:
obtain input data associated with a media instance, the media instance associated with a video, a single image, a set of images, a string of text, or combinations thereof corresponding to a geolocation;
provide the media instance as input to a predictive model to cause the predictive model to generate an intermediate set of data objects;
determine a final set of data objects based on the intermediate set of data objects and an inventory database, the final set of data objects comprising a plurality of data objects maintained in the inventory database and mapped to the intermediate set of data objects; and
generate user interface data configured to cause a client device having a display to generate a user interface on the display in accordance with the final set of data objects.
